(19) United States
(12) Patent Application Publication
(10) Pub. No.: US 2004/0194152 A1
(43) Pub. Date: Sep. 30, 2004

(54) Data processing method and data processing apparatus

(75) Inventors: Masayuki Yamada, Kanagawa (JP); Tsuyoshi Yagisawa, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/799,645

(22) Filed: Mar. 15, 2004

(30) Foreign Application Priority Data
Mar. 31, 2003 (JP) 2003-097135

(51) Int. Cl. H04N 7/173; H04N 7/10; H04N 7/025

(52) U.S. Cl. 725/135; 725/32; 725/133

(57) ABSTRACT

The invention provides a data processing method which can phonetically output execution of operation performed on an apparatus or a description of the operation content without requiring mode switching operation and without losing good sense of operability of the apparatus. Operation performed on the apparatus is detected, and the state of the apparatus at the time of operation detection is detected. In a case where the state of the apparatus is not the help mode, motion corresponding to the detected operation is executed. Meanwhile, in a case where the state of the apparatus is the help mode, a description of the motion corresponding to the detected operation is phonetically outputted, and information regarding the operation whose description has been phonetically outputted is stored in, e.g., motion buffer. Further, if the state of the apparatus is the help mode, motion corresponding to the operation is executed based on the information regarding the operation stored in the motion buffer.

### FIELD OF THE INVENTION

The present invention is directed to a data processing technique of phonetically outputting execution of operation performed on a data processing apparatus and a description of the operation.

### BACKGROUND OF THE INVENTION

Various data processing apparatuses have conventionally been providing particular modes, such as a help mode. For instance, a conventional data processing apparatus provides in advance a description of operation on an input device, e.g., a button operated by a user in the help mode. In a case where the data processing apparatus is in the help mode, in accordance with user's operation on an input device, a description of the operation content corresponding to the operated input device is presented to the user.

In this case, if the description of the operation content corresponding to the input device is presented by screen output, it causes disturbance on the monitor screen in operation and makes the user to think as if the internal state of the apparatus has changed. This imposes a psychological burden on the user, causing to lose good sense of operability of the data processing apparatus. In view of this, the technique conventionally available is to present a user with a description of operation content of the input device operated by the user by audio output. By providing the description of operation content with audio output instead of screen output, the monitor screen of the data processing apparatus in operation is no longer disturbed. Therefore, the user is able to receive the description of the operation content of the input device without changing the internal state of the apparatus, and it is possible to achieve good sense of operability of the data processing apparatus.

Furthermore, the audio function description is particularly advantageous to vision-impaired people since it is helpful to them.

However, the above-described conventional method has the following problems.

First of all, a user feels good sense of operability if the user can move on to execution of the desired input device immediately after the description of the operation content is presented. However, in the conventional data processing apparatus, the operation cannot be executed unless the user exits from the help mode. Therefore, in the conventional data processing apparatus, the user has to go back and forth between the help mode and the normal mode, deteriorating the good sense of operability of the data processing apparatus. In particular, this is more problematic for a case where the user is vision-impaired.

Furthermore, it is possible in the conventional technique to determine, to a certain degree, whether to present the description of the input device or to execute contents of the input device based on the amount of operation or the number of times of operation of the input device. However, in a case where the operation content of the input device changes in accordance with the amount of operation, the determination method that is based on the amount of operation of the input device cannot handle the situation. Furthermore, with the determination method that is based on the number of times of operation, if a user fails to hear the description on the operation content of the input device, the user is unable to listen to the description again, which is problematic.

### SUMMARY OF THE INVENTION

The present invention has been proposed to solve the conventional problems, and has as its object to provide a data processing method and a data processing apparatus which can realize audio output of execution of operation or a description of the operation performed on an apparatus without requiring mode switching operation and without losing good sense of operability of the apparatus.

To solve the above-described problems, the data processing method according to the present invention has the following characteristics. More specifically, the data processing method comprising an operation detection step of detecting operation performed on an apparatus, a state detection step of detecting a state of the apparatus when the operation is detected in the operation detection step, a first execution step of executing motion corresponding to the operation in a case where the state of the apparatus is not a help mode, an audio output step of phonetically outputting a description of the motion corresponding to the operation in a case where the state of the apparatus is the help mode, a storage step of storing in a predetermined storage device information regarding the operation, whose description has been phonetically outputted, and a second execution step of executing motion corresponding to the operation based on the information regarding the operation stored in the storage device, in a case where the state of the apparatus is the help mode.

Furthermore, to solve the above-described problems, the data processing apparatus according to the present invention has the following characteristics. More specifically, the data processing apparatus comprising operation detection means for detecting operation performed on an apparatus, state detection means for detecting a state of the apparatus when the operation detection means detects the operation, first execution means for executing motion corresponding to the operation in a case where the state of the apparatus is not a help mode, audio output means for phonetically outputting a description of the motion corresponding to the operation in a case where the state of the apparatus is the help mode, storage means for storing information regarding the operation, whose description has been phonetically outputted by the audio output means, and second execution means for executing motion corresponding to the operation based on the information regarding the operation stored in the storage means, in a case where the state of the apparatus is the help mode.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a block diagram showing a hardware configuration of a data processing apparatus capable of phonetically outputting a description of an operation content, such as input buttons or the like, according to the first embodiment of the present invention;

FIG. 2 is a flowchart describing an operation procedure of the data processing apparatus according to the first embodiment of the present invention;

FIG. 3 shows an example of an audio content outputted in button name speech synthesizing output step S12;

FIG. 4 shows an example of a content outputted in button-corresponding-motion-description speech synthesizing output step S14;

FIG. 5 shows an example of an audio content outputted in motion-result-description speech synthesizing output step S20; and

FIG. 6 is a part of a flowchart describing an operation procedure of a data processing apparatus according to the second embodiment of the present invention.

### DETAILED DESCRIPTION OF THE PREFERRED EMBODIMENTS

Preferred embodiments of the present invention will now be described in detail in accordance with the accompanying drawings.

<First Embodiment>

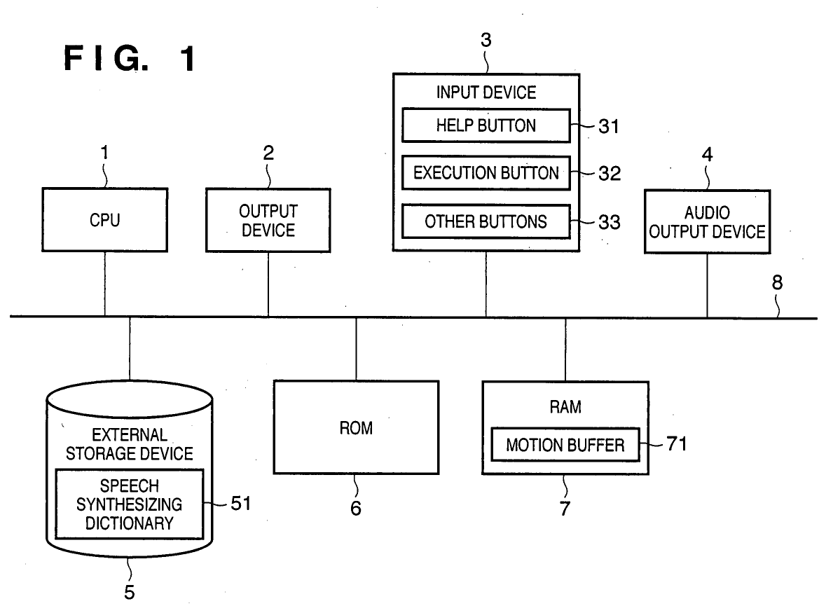

FIG. 1 is a block diagram showing a hardware configuration of a data processing apparatus capable of phonetically outputting a description of an operation content, such as input buttons or the like, according to the first embodiment of the present invention. In other words, as will be described in detail below, the data processing apparatus according to the first embodiment has a function that can phonetically output the description of an operation content corresponding to operation performed by a user, e.g., button depression, and has a function to cause the data processing apparatus to execute desired processing upon user's operation such as button depression in the help mode without switching the mode to the normal mode.

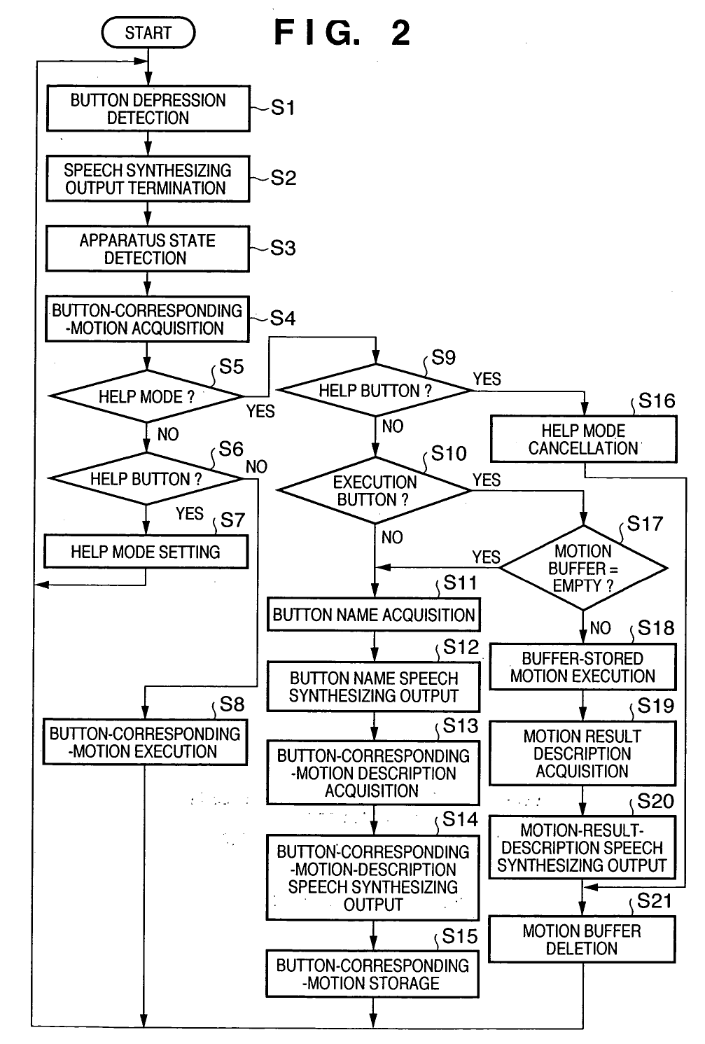

Referring to FIG. 1, numeral 1 denotes a central processing unit (CPU) which performs arithmetic calculation and controlling in accordance with a processing procedure shown in FIG. 2. Numeral 2 denotes an output device, e.g., a liquid crystal panel or the like, which presents data to a user. Numeral 3 denotes an input device, e.g., a touch panel, buttons, numeric keys and the like, which serves as an interface for a user to input an operation command or data to the data processing apparatus. The input device 3 includes a help button 31 and an execution button 32. Other buttons in the input device 3 (e.g., a reset button, a copy button or the like) are collectively referred to as “other buttons” 33 for ease of explanation.

Numeral 4 denotes an audio output device which outputs audio data synthesized in accordance with the content designated by the input device 3. Numeral 5 denotes an external storage device such as a disk device, non-volatile memory or the like, which includes a speech synthesizing dictionary 51. Numeral 6 denotes a read-only storage device (ROM) for storing processing procedures according to the first embodiment and other static data. Numeral 7 denotes a data storage device (RAM) for storing temporary data, various flags and so forth. Note that the RAM 7 includes a motion buffer 71. The aforementioned CPU 1, output device 2, input device 3, audio output device 4, external storage device 5, ROM 6 and RAM 7 are mutually connected through a bus 8.

FIG. 2 is a flowchart describing an operation procedure of the data processing apparatus according to the first embodiment of the present invention. With reference to the flowchart in FIG. 2, the operation of the data processing apparatus according to the first embodiment is described.

First, an input operation, e.g., button depression, performed on the data processing apparatus by a user using the input device 3 is detected (button depression detection step SI).

If the data processing apparatus is performing audio output of some kind at the time of input operation detection in step S1, the audio output is terminated (speech synthesizing output termination step S2). Next, an operation state of the data processing apparatus is detected (apparatus state detection step S3).

Next, motion corresponding to the type of button detected in step S1 in the operation state detected in step S3 is acquired (button-corresponding-motion acquisition step S4).

Next, it is determined whether or not the operation state of the apparatus detected in step S3 is the help mode (help mode determination step S5). As a result, if it is determined that the operation state is the help mode (YES), the control proceeds to second help button determination step S9. If it is determined that the operation state is not the help mode (NO), the control proceeds to first help button determination step S6.

In first help button determination step S6, it is determined whether or not the button detected in step S1 is the help button. As a result, if it is determined that the detected button is the help button (YES), the control proceeds to help mode setting step S7. If it is determined that the detected button is not the help button (NO), the control proceeds to button-corresponding-motion execution step S8.

In help mode setting step S7, the help mode is set as the operation state of the apparatus, and the control returns to step S1. In button-corresponding-motion execution step S8, the button corresponding motion acquired in step S4 is executed, thereafter the control returns to step S1.

In other words, according to the data processing apparatus of the first embodiment, in a case where the state of the apparatus is not the help mode and the detected operation is not the help operation, the motion corresponding to the detected operation is executed. Note that, as will be described later, it may be configured such that the result of the motion may be phonetically outputted after button-corresponding-motion execution step S8 is completed.

For instance, assuming a case where a user depresses a reset button while the state of the apparatus is not the help mode, the reset button depression is detected in step S1, audio output, if any being outputted, is terminated in step S2, the state of the apparatus not being the help mode is detected in step S3, and the button depression being the command for reset motion is acquired in step S4. Then, NO is determined in help mode determination step S5, NO is determined in first help button determination step S6, then reset motion is executed in button-corresponding-motion execution step S8, and the apparatus waits for the next button depression.

Meanwhile, in step S9, it is determined whether or not the button detected in step S1 is the help button. As a result, if it is determined that the detected button is the help button (YES), the control proceeds to help mode cancellation step S16. If it is determined that the detected button is not the help button (NO), the control proceeds to execution button determination step S10.

In step S10, it is determined whether or not the button detected in step S1 is an execution button. As a result, if it is determined that the detected button is the execution button (YES), the control proceeds to motion buffer content determination step S17. If it is determined that the detected button is not the execution button (NO), the control proceeds to button name acquisition step S11.

In step S11, the name of the button detected in step S1 in the state of the apparatus detected in step S3 is acquired. Next, the name of the button acquired in step S11 is outputted with synthesized speech (button name speech synthesizing output step S12).

Next, a description corresponding to the motion acquired in step S4 is acquired (button-corresponding-motion description acquisition step S13). Then, the description of the motion acquired in step S13 is outputted with synthesized speech (button-corresponding-motion-description speech synthesizing output step S14). In other words, according to the data processing apparatus of the first embodiment, in a case where the state of the apparatus is the help mode and the detected operation is not the help operation, a description of the motion corresponding to the detected operation is phonetically outputted.

Next, the motion acquired in step S4 is stored in the motion buffer 71 (button-corresponding-motion storage step S15), and the control returns to step S1.

For instance, assuming a case where a user depresses a reset button while the state of the apparatus is the help mode, the reset button depression is detected in step S1, audio output, if any being outputted, is terminated in step S2, the state of the apparatus being the help mode is detected in step S3, and the button depression being the command for reset motion is acquired in step S4. Then, YES is determined in help mode determination step S5, NO is determined in second help button determination step S9, and NO is determined in execution button determination step S10.

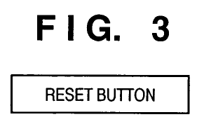

Next, the name “eset button” is acquired in step S11, and the name of the button is phonetically outputted in step S12. FIG. 3 shows an example of an audio content outputted in step S12. For instance, in a case where the reset button is acquired as the button name, the audio output device 4 outputs the speech “reset button.” Note that the first embodiment assumes that speech synthesizing output is executed asynchronously. Therefore, in step S12, the control proceeds to the next step S13 without waiting for completion of the button name speech synthesizing output. This is the reason that the first embodiment requires speech synthesizing output termination step S2. Furthermore, although the first embodiment assumes speech synthesis by rule (text-to-speech synthesis), a recording/playback method can realize the similar output.

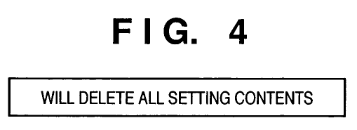

After the button name is phonetically outputted in step S12, a description regarding reset motion is acquired in step S13. Then, the description regarding reset motion is phonetically outputted in step S14. FIG. 4 shows an example of an output content outputted in step S14. For instance, the audio output device 4 outputs, following the speech “reset button,” “will delete all setting contents.” Thereafter, information regarding reset motion is stored in the motion buffer 71 in step S15, and the apparatus waits for the next button depression.

Note according to the first embodiment, in a case where the reset button is depressed one more time as the next button or a case where other buttons 33 excluding the help button 31 or execution button 32 are depressed, the above-described process is repeatedly executed as many times as the button is depressed.

Meanwhile, if it is determined in step S9 that the button is the help button (YES), the help mode set as the state of the apparatus is cancelled (help mode cancellation step S16), and the control proceeds to motion buffer deletion step S21.

If it is determined in step S10 that the button is the execution button (YES), then it is determined whether or not the content of the motion buffer 71 is empty (motion buffer content determination step S17). As a result, if it is determined that the motion buffer 71 is empty (YES), the control proceeds to step S11. If it is determined that the motion buffer 71 is not empty (NO), the control proceeds to buffer-stored motion execution step S18.

In step S18, the motion stored in the motion buffer 71 in step S15 is executed. Then, a description on the result of motion executed in step S18 is acquired (motion result description acquisition step S19). Then, the description on the result of motion acquired in step S19 is outputted with synthesized speech (motion-result-description speech synthesizing output step S20).

After the processing of help mode cancellation step S16 or motion-result-description speech synthesizing output step S20, the content of the motion buffer 71 is emptied (motion buffer deletion step S21), and the control returns to button depression detection step S1.

For instance, assuming a case where a user depresses a reset button then depresses the execution button 32 while the state of the apparatus is the help mode, the depression of the execution button 32 is detected in step S1, audio output, if any being outputted, is terminated in step S2, the state of the apparatus being the help mode is detected in step S3, and the button depression being the command for execution is acquired in step S4. Then, YES is determined in help mode determination step S5, NO is determined in second help button determination step S9, and YES is determined in execution button determination step S10.

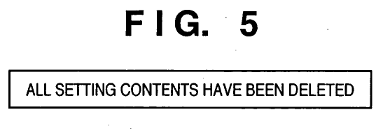

Next, NO is determined in motion buffer content determination step S17, and reset motion is executed in step S18. Further, a description on the result of reset motion is acquired in step S19, and the description on the result is phonetically outputted in step S20. FIG. 5 shows an example of an audio content outputted in motion-result-description speech synthesizing output step S20. For instance, the audio output device 4 outputs the speech “all setting contents have been deleted.” Next, the motion buffer 71 is emptied in step S21, and the apparatus waits for the next button depression.

As described above, the data processing-apparatus according to the first embodiment detects an operation performed on the apparatus and detects the state of the apparatus at the time of operation detection. When the state of the apparatus is not the help mode, motion corresponding to the detected operation is executed. Meanwhile, when the state of the apparatus is the help mode, a description on the motion corresponding to the detected operation is phonetically outputted, and information regarding the operation whose description has been phonetically outputted is stored in a predetermined storage device (e.g., motion buffer 71). Further, in a case where the state of the apparatus is the help mode, motion corresponding to the detected operation is executed based on the information regarding the operation stored in the storage device.

Furthermore, the above-described data processing apparatus detects a second operation performed on the apparatus, and detects the state of the apparatus at the time of second operation detection. When the detected state of the apparatus is the help mode, motion corresponding to the information regarding the operation stored in the storage device is executed.

Furthermore, according to the above-described data processing apparatus, in a case where the state of the apparatus is the help mode and the detected operation is help operation, the help mode is cancelled. In a case where the state of the apparatus is not the help mode and the detected operation is help operation, the state of the apparatus is set in the help mode.

As has been described above, according to the data processing apparatus of the first embodiment, even when the apparatus is in the help mode, a user is able to move on to execution of operation immediately after the user listens to the description of the operation; thus the sense of operability can be improved. Furthermore, even in a case of the input mode that changes its operation in accordance with the amount of operation, problems will not be caused unlike conventional data processing apparatuses. Moreover, the apparatus can achieve good sense of operability for a vision-impaired user since the user can move on to the next operation in the stage at which the user listens to the name of the input.

<Second Embodiment>

In addition to the configuration and operation of the above-described data processing apparatus according to the first embodiment, the second embodiment provides a data processing apparatus that can change sound quality of synthesized speech outputted for the second time on and after, in a case where the description of one same button is repeatedly outputted. For instance, volume, prosodic features such as vocalize speed, voice feature and the like of the synthesized speech can be changed. Described hereinafter is a case where the volume and vocalize speed are changed when synthesized speech is outputted for the second time on and after.

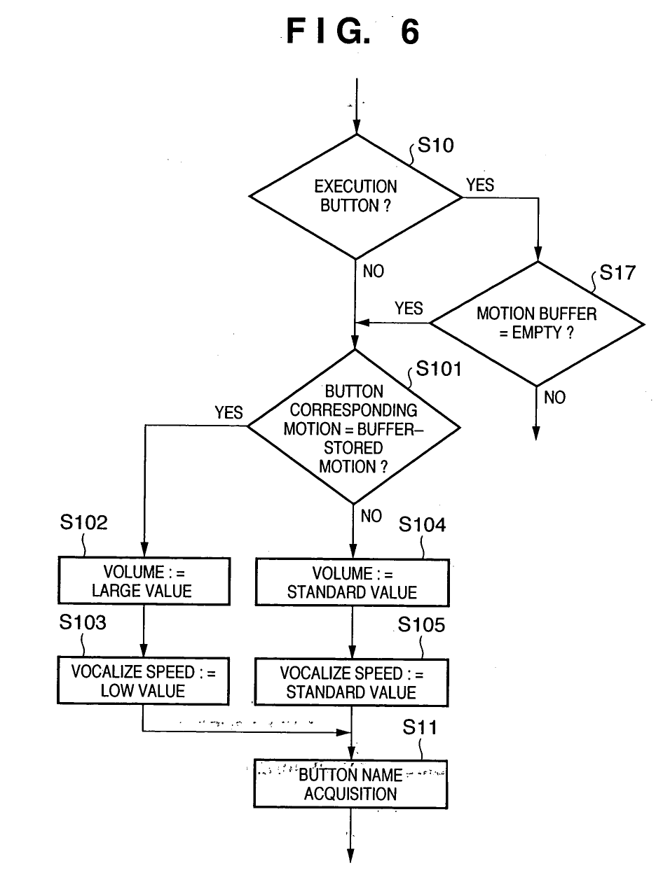

FIG. 6 is a part of a flowchart describing an operation procedure of the data processing apparatus according to the second embodiment of the present invention. In the flowchart shown in FIG. 6, steps S101 to S105 are newly added between execution button determination step S10 and button name acquisition step S11 in the flowchart in FIG. 2. Other procedure is the same as the one in the flowchart shown in FIG. 2.

First, if it is determined in step S10 that the detected button is not the execution button (NO), the motion acquired in step S4 is compared with the motion stored in the motion buffer 71 to determine whether or not they are the same motion (button-corresponding-motion buffer verification step S101). As a result, if the motion acquired in step S4 is the same as the motion stored in the motion buffer 71 (YES), the control proceeds to volume increasing step S102. Meanwhile, if the motion acquired in step S4 is not the same as the motion stored in the motion buffer 71 (NO), the control proceeds to standard volume setting step S104.

In step S102, a volume setting value for the speech synthesizing output is increased. More specifically, the volume may be relatively increased from the previously set value, or the volume may be set in a predetermined value of “large volume.” Next, a vocalize speed setting value for the speech synthesizing output is decreased (vocalize speed decreasing step S103). More specifically, the vocalize speed may be relatively decreased from the previously set value, or the vocalize speed may be set in a predetermined value of “slow speed.” After step S103, the control proceeds to button name acquisition step S11.

Meanwhile, in step S104, the volume for the speech synthesizing output is set in a standard value. Next, the vocalize speed for the speech synthesizing output is set in a standard value (standard vocalize speed setting step S105). After step S105, the control proceeds to button name acquisition step S11.

Besides the above-described change, voice feature can be altered by utilizing a voice feature converting filter or by changing a dictionary employed for speech synthesizing. Note that, in order to change sound quality other than the volume by utilizing the recording/playback method, different playback data must be used.

Compared to the data processing apparatus according to the first embodiment, the data processing apparatus according to the second embodiment is characterized in that determination is made as to whether or not the same operation is repeatedly performed on the apparatus, and in a case where the same operation is repeatedly performed, sound quality of the output speech is changed from the speech outputted last.

As has been described above, according to the second embodiment, even if a user fails to hear the description on the input device, the user can listen to the same description by performing the same input again. In this case, processing such as the volume increase or the like is possible to assure that the user can hear the description.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As described above, according to the present invention, it is possible to realize audio output of execution of operation or a description of the operation content performed on an apparatus without requiring mode switching operation and without losing good sense of operability of the apparatus.

The present invention is not limited to the above embodiments and various changes and modification can be made within the spirit and scope of the present inventions. Therefore, to apprise the public of the scope of the present invention, the following claims are made.

What is claimed is:

1. A data processing method comprising:
an operation detection step of detecting operation performed on an apparatus;
a state detection step of detecting a state of the apparatus when said operation is detected in said operation detection step;
a first execution step of executing motion corresponding to said operation in a case where the state of the apparatus is not a help mode;
an audio output step of phonetically outputting a description of the motion corresponding to said operation in a case where the state of the apparatus is the help mode;
a storage step of storing in a predetermined storage device information regarding said operation, whose description has been phonetically outputted; and
a second execution step of executing motion corresponding to said operation based on the information regarding said operation stored in the storage device, in a case where the state of the apparatus is the help mode.

2. The data processing method according to claim 1, further comprising:
a second operation detection step of detecting second operation performed on the apparatus; and
a second state detection step of detecting a state of the apparatus when the second operation is detected in said second detection step,
wherein in said second execution step, motion corresponding to the information regarding said operation stored in the storage device is executed in a case where the state of the apparatus detected in said second state detection step is the help mode.

3. The data processing method according to claim 1, further comprising:
a cancellation step of canceling the help mode of the apparatus in a case where the state of the apparatus is the help mode and said operation is help operation; and
a setting step of setting the state of the apparatus in the help mode in a case where the state of the apparatus is not the help mode and said operation is help operation.

4. The data processing method according to claim 1, wherein in said first execution step, motion corresponding to said operation is executed in a case where the state of the apparatus is not the help mode and said operation is not help operation.

5. The data processing method according to claim 1, wherein in said audio output step, the description of the motion corresponding to said operation is phonetically outputted in a case where the state of the apparatus is the help mode and said operation is not help operation.

6. The data processing method according to claim 1, further comprising a termination step of terminating audio output being currently outputted in a case where operation performed on the apparatus is detected in said operation detection step.

7. The data processing method according to claim 1, further comprising a second audio output step of phonetically outputting a motion result of said operation executed in said second execution step.

8. The data processing method according to claim 1, further comprising:
an acquisition step of acquiring a name of said operation performed on the apparatus; and
a third audio output step of phonetically outputting the name before phonetically outputting the description of the motion in said audio output step.

9. The data processing method according to claim 1, further comprising:
a determination step of determining whether or not one same operation has been repeatedly performed on the apparatus; and
a changing step of changing sound quality of output speech from the speech outputted last, in a case where one same operation has been repeatedly performed.

10. The data processing method according to claim 9, wherein in said changing step, vocalize speed of the output speech is changed.

11. The data processing method according to claim 9, wherein in said changing step, volume of the output speech is changed.

12. The data processing method according to claim 9, wherein in said changing step, vocal quality of the output speech is changed.

13. A data processing apparatus comprising:
operation detection means for detecting operation performed on an apparatus;
state detection means for detecting a state of the apparatus when said operation detection means detects said operation;
first execution means for executing motion corresponding to said operation in a case where the state of the apparatus is not a help mode;
audio output means for phonetically outputting a description of the motion corresponding to said operation in a case where the state of the apparatus is the help mode;
storage means for storing information regarding said operation, whose description has been phonetically outputted by said audio output means; and
second execution means for executing motion corresponding to said operation based on the information regarding said operation stored in said storage means, in a case where the state of the apparatus is the help mode.

14. A program which causes a computer to execute:
an operation detection procedure for detecting operation performed on an apparatus;
a state detection procedure for detecting a state of the apparatus when said operation is detected by said operation detection procedure;
a first execution procedure for executing motion corresponding to said operation in a case where the state of the apparatus is not a help mode;
an audio output procedure for phonetically outputting a description of the motion corresponding to said operation in a case where the state of the apparatus is the help mode;
a storage procedure for storing in a predetermined storage device information regarding said operation, whose description has been phonetically outputted by said audio output procedure; and
a second execution procedure for executing motion corresponding to said operation based on the information regarding said operation stored in the storage device, in a case where the state of the apparatus is the help mode.

15. A computer-readable recording medium which stores the program described in claim 14.
